(19) United States
(12) Patent Application Publication
(10) Pub. No.: US 2013/0151817 A1
(43) Pub. Date: Jun. 13, 2013

(54) METHOD, APPARATUS, AND COMPUTER PROGRAM PRODUCT FOR PARALLEL FUNCTIONAL UNITS IN MULTICORE PROCESSORS

(71) Applicant: Mika Juhani Lähteenmäki, Tampere (FI)

(72) Inventor: Mika Juhani Lähteenmäki, Tampere (FI)

(73) Assignee: Nokia Corporation, Espoo (FI)

(21) Appl. No.: 13/315,629

(22) Filed: Dec. 9, 2011

(51) Int. Cl. G06F 9/30; G06F 9/38

(52) U.S. Cl. 712/208; 712/216; 712/E09.016; 712/E09.028; 712/E09.045

(57) ABSTRACT

Method, apparatus, and computer program product embodiments of the invention maximize the use of functional processing units in a multicore processor integrated circuit architecture. Example embodiments of the invention determine that instructions to be executed in a functional processor of a local processor core of a multicore processor, are capable of execution in a functional processor of a neighbor processor core of the multicore processor. A compute request is sent to the neighbor processor core to initiate execution of the instructions in the functional processor. A compute response is received from the neighbor processor core, if the functional processor has been able to execute the instructions.

### FIELD

The embodiments relate to the architecture of integrated circuit computer processors, and more particularly to maximizing the use of functional processor units in a multicore processor integrated circuit architecture.

### BACKGROUND

Traditional telephones have evolved into smartphones that have advanced computing ability and wireless connectivity. A modern smartphone typically includes a high-resolution touchscreen, a web browser, GPS navigation, speech recognition, sound synthesis, a video camera, Wi-Fi, and mobile broadband access, combined with the traditional functions of a mobile phone. Providing so many sophisticated technologies in a small, portable package, has been possible by implementing the internal electronic components of the smartphone in high density, large scale integrated circuitry.

A multicore processor is a multiprocessing system embodied on a single large scale integrated semiconductor chip. Typically two or more processor cores may be embodied on the multicore processor chip, interconnected by a bus that may also be formed on the same multicore processor chip. There may be from two processor cores to many processor cores embodied on the same multicore processor chip, the upper limit in the number of processor cores being limited by only by manufacturing capabilities and performance constraints. The multicore processors may have applications including specialized arithmetic and/or logical operations performed in multimedia and signal processing algorithms such as video encoding/decoding, 2D/3D graphics, audio and speech processing, image processing, telephony, speech recognition, and sound synthesis.

### SUMMARY

Method, apparatus, and computer program product embodiments of the invention are disclosed to maximize the use of functional processing units in a multicore processor integrated circuit architecture

In example embodiments of the invention, a method comprises:

determining that one or more instructions to be executed in a functional processor of a local processor core of a multicore processor, are capable of execution in a functional processor of at least one neighbor processor core of the multicore processor;

sending a compute request to the at least one neighbor processor core to initiate execution of the one or more instructions in the functional processor of the at least one neighbor processor core;

receiving a busy indication from the at least one neighbor processor core, if the functional processor of the at least one neighbor processor core is not able to execute the one or more instructions; and

receiving a compute response from the at least one neighbor processor core, if the functional processor of the at least one neighbor processor core has been able to execute the one or more instructions.

In example embodiments of the invention, the method further comprises:

wherein the compute request includes the one or more instructions and operands.

In example embodiments of the invention, the method further comprises:

wherein the compute response includes a computation result of executing the one or more instructions in the functional processor of the at least one neighbor processor core.

In example embodiments of the invention, the method further comprises:

wherein if the busy indication is received from the at least one neighbor processor core, then executing the one or more instructions in the functional processor of the local processor core.

In example embodiments of the invention, the method further comprises:

duplicating in a bus interface in the local processor core, the one or more instructions to be executed in the functional processor of the local processor core;

decoding in the bus interface, the one or more instructions that have been duplicated in the bus interface, to perform the determining that the one or more instructions are capable of execution in the functional processor of the at least one neighbor processor core; and

sending by the bus interface the compute request, to the at least one neighbor processor core, over a bus coupled to the at least one neighbor processor core, to initiate execution of the one or more instructions in the functional processor of the at least one neighbor processor core.

In example embodiments of the invention, an apparatus comprises:

at least one processor;

at least one memory including computer program code;

the at least one memory and the computer program code configured to, with the at least one processor, cause the apparatus at least to:

determine that one or more instructions to be executed in a functional processor of a local processor core of a multicore processor, are capable of execution in a functional processor of at least one neighbor processor core of the multicore processor;

send a compute request to the at least one neighbor processor core to initiate execution of the one or more instructions in the functional processor of the at least one neighbor processor core;

receive a busy indication from the at least one neighbor processor core, if the functional processor of the at least one neighbor processor core is not able to execute the one or more instructions; and

receive a compute response from the at least one neighbor processor core, if the functional processor of the at least one neighbor processor core has been able to execute the one or more instructions.

In example embodiments of the invention, the apparatus further comprises:

wherein the compute request includes the one or more instructions and operands,

In example embodiments of the invention, the apparatus further comprises:

wherein the compute response includes a computation result of executing the one or more instructions in the functional processor of the at least one neighbor processor core.

In example embodiments of the invention, the apparatus further comprises:

the at least one memory and the computer program code configured to, with the at least one processor, cause the apparatus at least to:

execute the one or more instructions in the functional processor of the local processor core, if the busy indication is received from the at least one neighbor processor core.

In example embodiments of the invention, the apparatus further comprises:

a bus interface unit configured to send the compute request to the at least one neighbor processor core;

the bus interface unit further configured to receive the busy indication from the at least one neighbor processor core, if the functional processor of the at least one neighbor processor core is not able to execute the one or more instructions; and

the bus interface unit further configured to receive the compute response from the at least one neighbor processor core, if the functional processor of the at least one neighbor processor core has been able to execute the one or more instructions.

In example embodiments of the invention, the apparatus further comprises:

the at least one memory and the computer program code configured to, with the at least one processor, cause the apparatus at least to:

duplicate in a bus interface in the local processor core, the one or more instructions to be executed in the functional processor of the local processor core;

decode in the bus interface, the one or more instructions that have been duplicated in the bus interface, to perform the determining that the one or more instructions are capable of execution in the functional processor of the at least one neighbor processor core; and

send by the bus interface over a bus coupled to the at least one neighbor processor core, the compute request to the at least one neighbor processor core to initiate execution of the one or more instructions in the functional processor of the at least one neighbor processor core.

In example embodiments of the invention, the apparatus may be a component of an electronic device, such as for example a mobile phone, a smart phone, or a portable computer, in accordance with at least one embodiment of the present invention.

In example embodiments of the invention, a computer program product comprising computer executable program code recorded on a computer readable, non-transitory storage medium, the computer executable program code, when executed by a computer processor in an apparatus, comprises:

code for determining that one or more instructions to be executed in a functional processor of a local processor core of a multicore processor, are capable of execution in a functional processor of at least one neighbor processor core of the multicore processor;

code for sending a compute request to the at least one neighbor processor core to initiate execution of the one or more instructions in the functional processor of the at least one neighbor processor core;

code for receiving a busy indication from the at least one neighbor processor core, if the functional processor of the at least one neighbor processor core is not able to execute the one or more instructions; and

code for receiving a compute response from the at least one neighbor processor core, if the functional processor of the at least one neighbor processor core has been able to execute the one or more instructions.

In example embodiments of the invention, a method comprises:

receiving, in a local processor core of a multicore processor, a compute request to initiate execution of one or more instructions in a functional processor in the local processor core;

sending a busy indication to a neighbor processor core of the multicore processor, if the one or more instructions cannot be executed in the functional processor; and

sending a compute response to the neighbor processor core, if the one or more instructions have been executed in the functional processor.

In example embodiments of the invention, the method further comprises:

wherein the compute request includes the one or more instructions and operands.

In example embodiments of the invention, the method further comprises:

wherein the compute response includes a computation result of executing the one or more instructions.

In example embodiments of the invention, the method further comprises:

wherein the busy indication is sent to the neighbor processor core to cause the neighbor processor core to execute in its own functional processor, the one or more instructions.

In example embodiments of the invention, the method further comprises:

duplicating in a bus interface in the local processor core, instructions to be executed in the local processor core;

decoding in the bus interface, the one or more instructions, to determine whether the one or more instructions are capable of execution in the functional processor; and

sending by the bus interface over a bus coupled to the neighbor processor core, the compute response that the one or more instructions have been executed in the functional processor.

In example embodiments of the invention, an apparatus comprises:

at least one processor;

at least one memory including computer program code;

the at least one memory and the computer program code configured to, with the at least one processor, cause the apparatus at least to:

receive, in a local processor core of a multicore processor, a compute request to initiate execution of one or more instructions in a functional processor in the local processor core;

send a busy indication to a neighbor processor core of the multicore processor, if the one or more instructions cannot be executed in the functional processor; and

send a compute response to the neighbor processor core, if the one or more instructions have been executed in the functional processor.

In example embodiments of the invention, the apparatus further comprises:

wherein the compute request includes the one or more instructions and operands.

In example embodiments of the invention, the apparatus further comprises:

wherein the compute response includes a computation result of executing the one or more instructions.

In example embodiments of the invention, the apparatus further comprises:

wherein the busy indication is sent to the neighbor processor core to cause the neighbor processor core to execute the one or more instructions in its own functional processor.

In example embodiments of the invention, the apparatus further comprises:

a bus interface unit configured to receive the compute request;

the bus interface unit further configured to send the busy indication to the neighbor processor core, if the one or more instructions cannot be executed; and

the bus interface unit further configured to send the computation result to the neighbor processor core, if the one or more instructions have been executed.

In example embodiments of the invention, the apparatus further comprises:

the at least one memory and the computer program code configured to, with the at least one processor, cause the apparatus at least to:

duplicate in a bus interface in the local processor core, instructions to be executed in the local processor core;

decode in the bus interface, the one or more instructions, to determine whether the one or more instructions are capable of execution in the functional processor; and

send by the bus interface over a bus coupled to the neighbor processor core, the compute response that the one or more instructions have been executed in the functional processor.

In example embodiments of the invention, a computer program product comprising computer executable program code recorded on a computer readable, non-transitory storage medium, the computer executable program code, when executed by a computer processor in an apparatus, comprises:

code for receiving, in a local processor core of a multicore processor, a compute request to initiate execution of one or more instructions in a functional processor in the local processor core;

code for sending a busy indication to a neighbor processor core of the multicore processor, if the one or more instructions cannot be executed in the functional processor; and

code for sending a compute response to the neighbor processor core, if the one or more instructions have been executed in the functional processor.

In example embodiments of the invention, an apparatus comprises:

means for determining that one or more instructions to be executed in a functional processor of a local processor core of a multicore processor, are capable of execution in a functional processor of at least one neighbor processor core of the multicore processor;

means for sending a compute request to the at least one neighbor processor core to initiate execution of the one or more instructions in the functional processor of the at least one neighbor processor core;

means for receiving a busy indication from the at least one neighbor processor core, if the functional processor of the at least one neighbor processor core is not able to execute the one or more instructions; and

means for receiving a compute response from the at least one neighbor processor core, if the functional processor of the at least one neighbor processor core has been able to execute the one or more instructions.

In example embodiments of the invention, an apparatus comprises:

means for receiving, in a local processor core of a multicore processor, a compute request to initiate execution of one or more instructions in a functional processor in the local processor core;

means for sending a busy indication to a neighbor processor core of the multicore processor, if the one or more instructions cannot be executed in the functional processor; and

means for sending a compute response to the neighbor processor core, if the one or more instructions have been executed in the functional processor.

In this manner, embodiments of the invention maximize the use of functional processing units in a multicore processor integrated circuit architecture.

### DESCRIPTION OF THE FIGURES

FIG. 1 illustrates an example embodiment of the system architecture, in accordance with example embodiments of the invention.

FIG. 2A illustrates an example embodiment of the processor core architecture, in accordance with an example embodiment of the invention.

FIG. 2B illustrates an example embodiment of the instruction queue in the bus interface in the processor core 1 of FIG. 2A, forming compute request messages, in accordance with an example embodiment of the invention.

FIG. 2C illustrates an example embodiment of the instruction queue in the bus interface in the processor core 2 of FIG. 2A, forming a compute response message, in accordance with an example embodiment of the invention.

FIG. 2D illustrates an example embodiment of the instruction queue in the bus interface in the processor core 2 of FIG. 2A, forming a busy indication message, in accordance with an example embodiment of the invention.

FIG. 3A illustrates an example embodiment of the processor core 1 detecting a “PARALLEL(3)” instruction for its functional processor, in the instruction queue of its bus interface, executing the next instruction in the queue and sending two compute requests to processor cores 2 and 3 to respectively execute the second next and third next instructions in the queue in parallel, in accordance with an example embodiment of the invention.

FIG. 3B illustrates an example timing diagram of an example operation of the example embodiment of the invention shown in FIG. 3A, according to an embodiment of the present invention.

FIG. 4A illustrates an example embodiment of the processor core 2 detecting a busy condition for its functional processor and sending a busy indication to the processor core 1, the processor 1 then executing the second next instruction in the instruction queue, in accordance with an example embodiment of the invention.

FIG. 4B illustrates an example timing diagram of an example operation of the example embodiment of the invention shown in FIG. 4A, according to an embodiment of the present invention.

FIG. 5A illustrates an example embodiment of the compute request bus message, according to an embodiment of the present invention.

FIG. 5B illustrates an example embodiment of the compute response bus message, according to an embodiment of the present invention.

FIG. 5C illustrates an example embodiment of the busy indication bus message, according to an embodiment of the present invention.

FIG. 5D illustrates an example timing diagram of two compute request bus messages separated by an arbitration period, according to an embodiment of the present invention.

FIG. 6A illustrates an example flow diagram of an example process carried out in the processor core 1, according to an embodiment of the present invention.

FIG. 6B illustrates an example flow diagram of an example process carried out in the processor core 2, according to an embodiment of the present invention.

FIG. 7 illustrates an example embodiment of the invention, wherein examples of removable storage media are shown, based on magnetic, electronic and/or optical technologies, such as magnetic disks, optical disks, semiconductor memory circuit devices, and micro-SD semiconductor memory cards (SD refers to the Secure Digital standard) for storing data and/or computer program code as an example computer program product, in accordance with at least one embodiment of the present invention.

FIG. 8A illustrates an example embodiment of the invention, wherein the multicore processor MP is a component of a mobile phone 800A, in accordance with at least one embodiment of the present invention.

FIG. 8B illustrates an example embodiment of the invention, wherein the multicore processor MP is a component of a smart phone 800B, in accordance with at least one embodiment of the present invention.

FIG. 8C illustrates an example embodiment of the invention, wherein the multicore processor MP is a component of a portable computer 800C, in accordance with at least one embodiment of the present invention.

### DISCUSSION OF EXAMPLE EMBODIMENTS OF THE INVENTION:

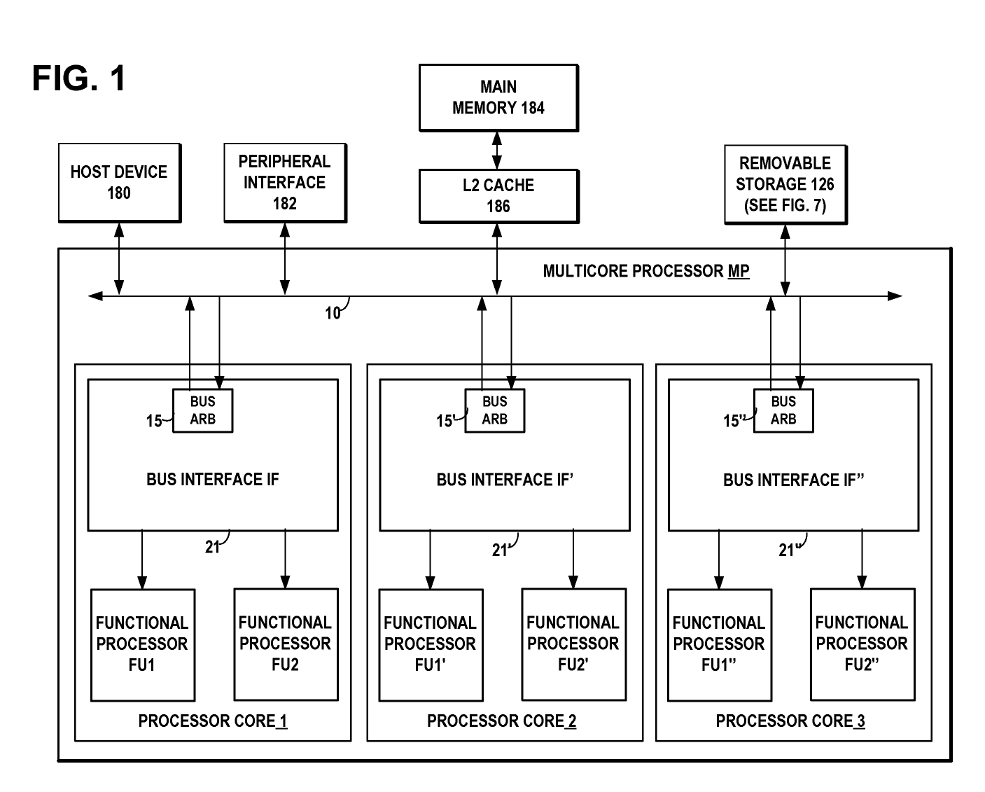

FIG. 1 illustrates an example system architecture of a multicore processor MP embodied on a single semiconductor chip, in accordance with example embodiments of the invention. The example embodiment shown has three processor cores 1, 2, and 3 embodied on the multicore processor MP chip, interconnected by a bus 10 that is also formed on the same multicore processor MP chip. In the example embodiment shown, each processor core 1, 2, and 3 is respectively connected to the bus 10 by a respective bus interface unit IF 21, 21′, and 21″ within its respective processor core. In example embodiments of the invention, there may be from two processor cores to many processor cores embodied on the same multicore processor MP chip, the upper limit in the number of processor cores being limited by only by manufacturing capabilities and performance constraints. In example embodiments of the invention, the bus 10 may also be a ring, two-dimensional mesh, crossbar, or other network topology interconnecting the processor cores 1, 2, and 3 on the multicore processor MP chip. In example embodiments of the invention, the processor cores 1, 2, and 3 may be identical cores. In example embodiments of the invention, the processor cores 1, 2, and 3 may not be identical, except for similar or identical functional processors or functional units FU1 and/or FU2 in the respective processor cores, as will become clearer as this discussion proceeds. The processor cores 1, 2, and 3 may be respectively connected to the bus 10 through respective bus arbitration logic 15 in the respective bus interface units IF 21, 21′, and 21″. The terms functional unit, functional processor, and functional processor unit are used interchangeably herein.

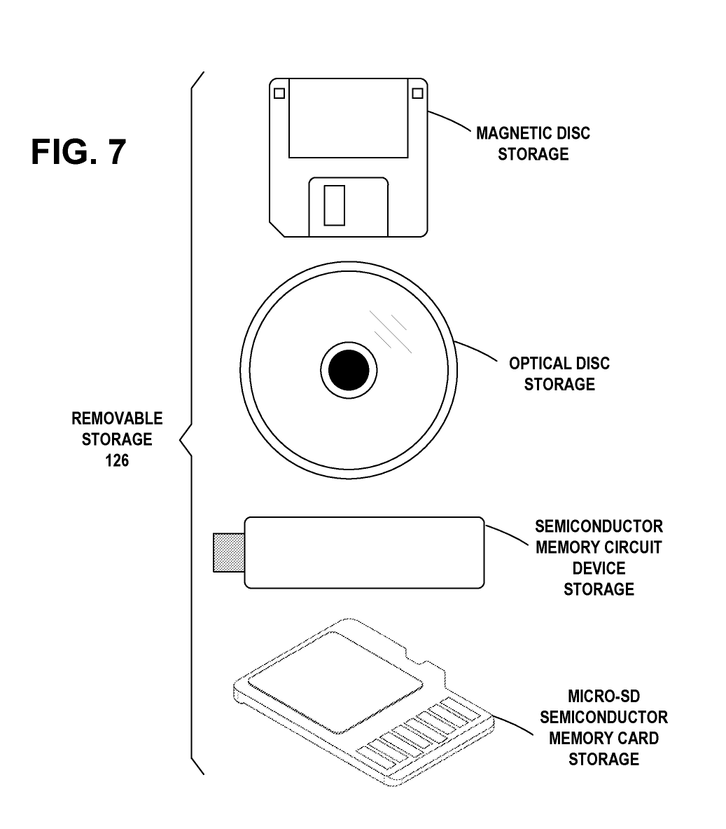

In example embodiments of the invention, the bus 10 may be connected to an Level 2 (L2) cache 186 on the same semiconductor chip or of a separate semiconductor chip. The L2 cache may be connected to a main memory 184 and/or other forms of bulk storage of data and/or program instructions. In example embodiments of the invention, the processor cores 1, 2, and 3 may be embodied on two or more separate semiconductor chips that are interconnected by the bus 10 and packaged in a multi-chip module. The bus physical layer may be embodied as two lines, a clock line and a data line that uses non-return-to-zero signals to represent binary values. In example embodiments of the invention, the bus 10 may be connected to a removable storage 126 shown in FIG. 7, based on magnetic, electronic and/or optical technologies such as magnetic disks, optical disks, semiconductor memory circuit devices, and micro-SD semiconductor memory cards (SD refers to the Secure Digital standard) that may serve, for instance, as a program code and/or data input/output means.

FIG. 1 shows the multicore processor bus 10 of FIG. 1 connected to the host device 180, such as a network element, direct memory access (DMA) controller, microcontroller, digital signal processor, or memory controller. The term “host device”, as used herein, may include any device that may initiate accesses to slave devices, and should not be limited to the examples given of network element, direct memory access (DMA) controller, microcontroller, digital signal processor, or memory controller. Multicore processor bus 10 may be connected to any kind of peripheral interface 182, such as camera, display, audio, keyboard, or serial interfaces. The term “peripheral interface”, as used herein, may include any device that can be accessed by a processor or a host device, and should not be limited to the examples given of camera, display, audio, keyboard, or serial interfaces, in accordance with at least one embodiment of the present invention.

In example embodiments of the invention, the processor cores 1, 2, and/or 3 may implement specialized architectures such as superscalar, very long instruction word (VLIW), vector processing, single instruction/multiple data (SIMD), or multithreading. In example embodiments of the invention, the functional processors FU1 and/or FU2 in the multicore processor MP, may have applications including specialized arithmetic and/or logical operations performed in multimedia and signal processing algorithms such as video encoding/decoding, 2D/3D graphics, audio and speech processing, image processing, telephony, speech recognition, and sound synthesis.

In example embodiments of the invention, the functional processor FU1 in processor core 1 may be similar to or identical to the functional processor FU1 in one or both of the processor cores 2 and 3. In example embodiments of the invention, a process that is running on a local processor core, for example processor core 1, may utilize for a computation the functional processor FU1 of the neighbor processor cores 2 and/or 3 in the multicore processor MP, if the neighboring functional processors FU1 of the neighbor processor cores 2 and/or 3 are not currently in use. In example embodiments of the invention, a specific new instruction executed in the local processor core 1, for example, will make available for the computation the neighboring functional processors FU1 of the neighbor processor cores 2 and/or 3, if the neighboring functional processors are not busy. If the neighboring functional processors FU1 are not available, then the computation is executed in the local functional processor FU1 of the local processor core 1.

In example embodiments of the invention, the functional processor FU1 may be an identical vector processing unit in each of the processor cores 1, 2, and 3. If the processes running on neighbor processor cores 2 and 3 are not using the FU1 vector processing capability, then a process running on the local processing core 1 may utilize the functional processor FU1 in processor cores 2 and/or 3 to carry out FU1 vector processing computations. In this manner, the parallel operations carried out in otherwise unused functional processors make much more efficient use of the multicore processor MP.

In example embodiments of the invention, the functional processor FU1 in processor cores 1, 2, and 3 may be a vector processor. A vector is a one-dimensional array of data, consisting of a collection of variables identified by an index, such as V1, V2, V3, . . . Vn, where each element Vi may take on an integer value. The elements of a vector may be sequentially stored in contiguous locations of a vector register or memory. A vector instruction may be an arithmetic or logical operation performed on the elements of a vector. For example, the vector instruction, ADD V1, V2, V3, may be defined as operation of computing the sum V3=V1+V2. In example embodiments of the invention, the functional processor FU1 may execute vector instructions using an instruction pipeline, where the instructions pass through sequential stages of decoding the instruction, fetching the values of the elements V1, V2, etc. from vector registers or memory, performing the arithmetic or logical operation on the elements, and storing the result back in the vector registers of memory. The stages of an instruction pipeline may operate in an overlapped manner, for example where the next instruction is decoded before the arithmetic operation is completed for first instruction.

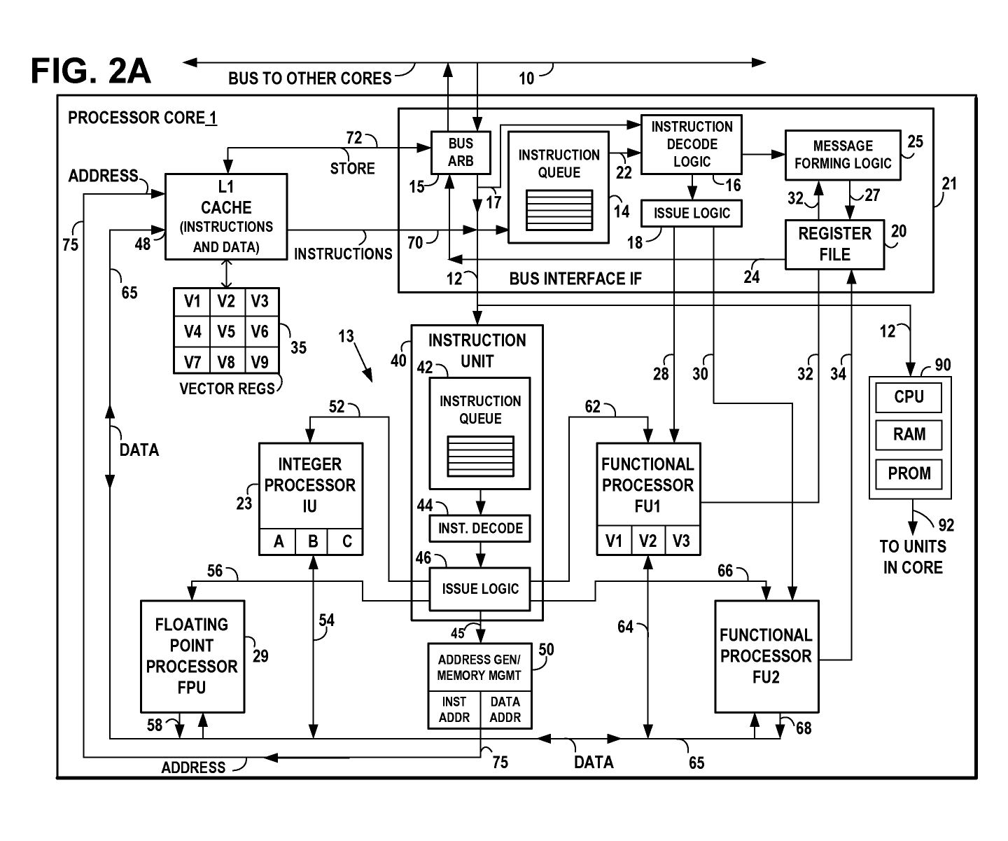

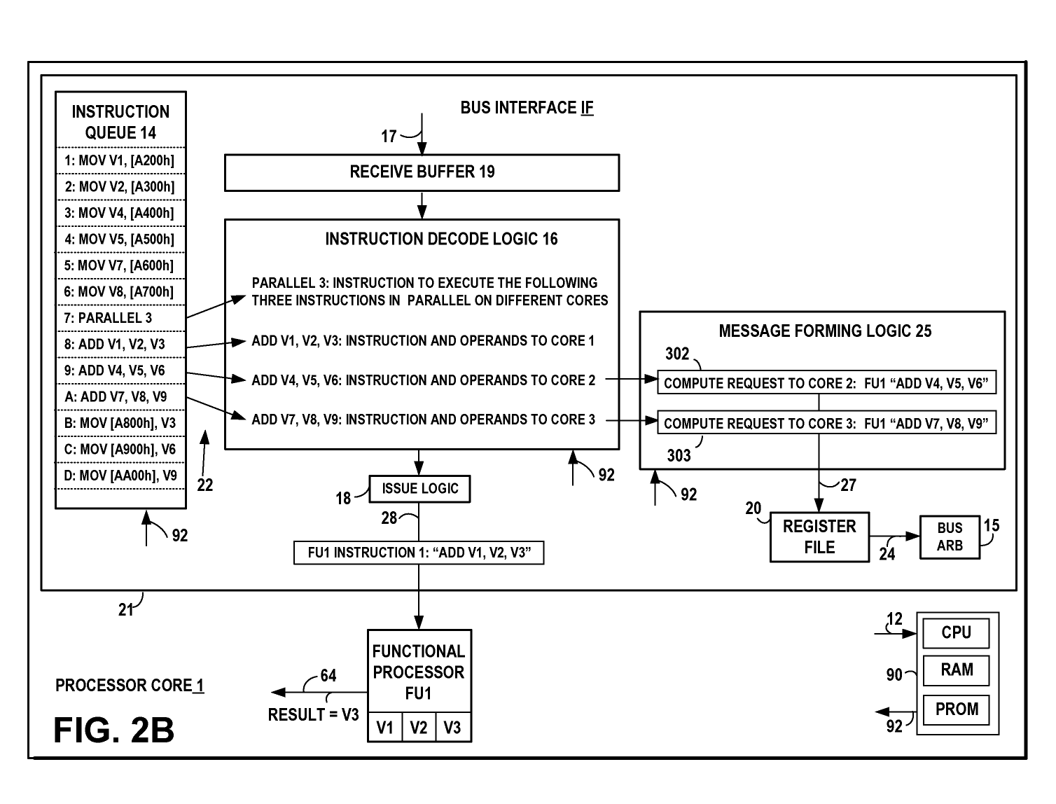

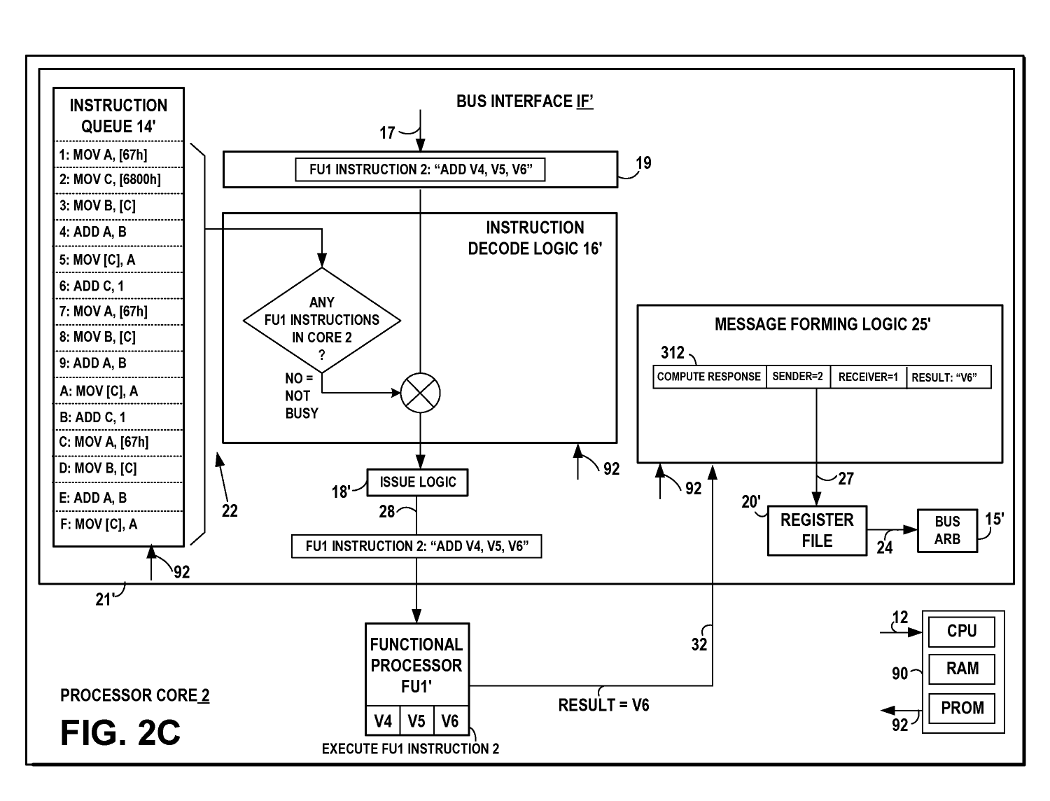

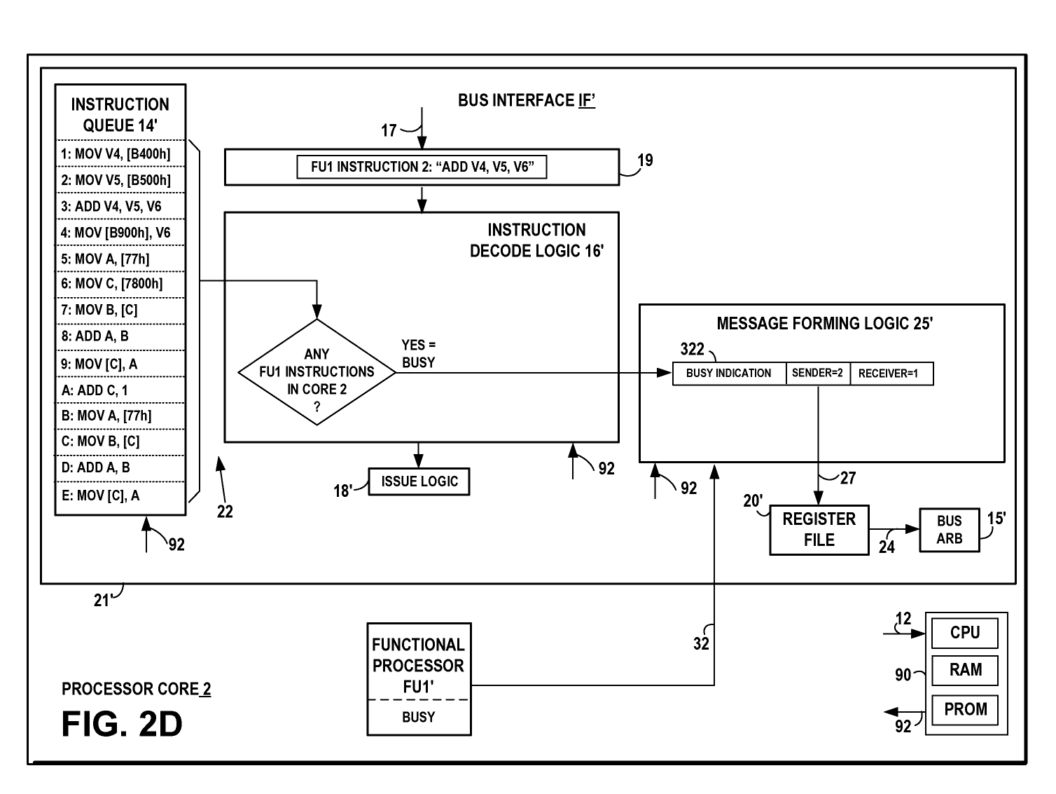

FIG. 2A illustrates an example processor core architecture, in accordance with an example embodiment of the invention. The figure depicts the architecture for processor core 1, however in example embodiments of the invention, the architectures of processor cores 2 and 3 may be similar or the same as that for processor core 1. In the example embodiment shown in FIG. 2A, processor core 1, embodied on the multicore processor MP chip, is interconnected by the bus 10 to the processor cores 2 and 3 embodied on the multicore processor MP chip.

In example embodiments of the invention, the processor core 1 may be connected through the bus arbitration logic 15 of the bus interface unit IF 21, to the bus 10 within its processor core. Instructions and data may pass into and out of the processor core 1 through the bus arbitration logic 15. The link layer of the bus 10 uses an arbitration period before sending a packet. The sender will wait for a short, random interval before trying to send the packet. After the interval, the sender checks if the bus is idle and if it is, it starts transmitting. The arbitration scheme enables all processor cores equal access to the bus 10. Instructions and data may be stored in the Level 1 (L1) cache 48 from the L2 cache and/or the main memory via the bus 10, bus arbitration logic 15, and line 72.

In example embodiments of the invention, FIG. 2A shows a pipelined processor structure 13 within the processor core 1, which is similar or substantially the same in each processor core 1, 2, and 3. The pipelined processor structure 13 within the processor core 1, includes an instruction unit 40 that contains an instruction queue 42, a decoder 44 and an issue logic 46 to provide centralized control of the flow of instructions in the instruction pipeline. The instructions pass through sequential stages of decoding the instruction, fetching the values of operands from registers or memory, performing the arithmetic or logical operation on the operands, and storing the results back in the registers or memory. The pipelined processor structure 13 within the processor core 1, includes the instruction unit 40, the floating point processor 29 execution unit FPU, the integer processor IU 23, the functional processor FU1, the functional processor FU2, and the address generator/memory management unit 50. The stages of the pipelined processor structure 13 may operate in an overlapped manner, for example where the next instruction is decoded before the arithmetic or logical operation is completed for first instruction. In the pipelined processor structure 13 within the processor core 1, the instruction unit 40 issues floating point instructions to floating point processor 29 execution unit FPU over line 56, issues integer instructions to the integer processor IU 23 over line 52, issues functional processing FU1 instructions to the functional processor FU1 over line 62, issues functional processing FU2 instructions to the functional processor FU2 over line 66, and issues memory management instructions to the address generator/memory management unit 50 over line 45.

In example embodiments of the invention, the address generator/memory management unit 50 provides the L1 cache 48 with the address of the next instruction to be fetched, over the line 75. In the case of a cache hit, the L1 cache 48 returns the instruction over line 70 and as many of the instructions following it as can be placed in the instruction queue 42, up to the cache sector boundary. In example embodiments of the invention, the same instructions are placed in the instruction queue 14 of the bus interface IF 21, to enable the instruction decode logic 16 in the bus interface IF 21 to determine whether either of the functional processor FU1 or FU2 is currently busy. In example embodiments of the invention, the address generator/memory management unit 50 also provides the L2 cache 48 with the address over the line 75, of data to be read or written over the data line 65. In example embodiments of the invention, the address generator/memory management unit 50 also enables transfers of data between the L1 cache 48 and the general purpose registers A, B, and C of the integer processor IU 23. In example embodiments of the invention, the address generator/memory management unit 50 also enables transfers of data between the L1 cache 48 and the vector registers 35.

In example embodiments of the invention, the integer processor IU 23 receives integer instructions over line 52 from the instruction queue 42, decoder 44 and issue logic 46 in the instruction unit 40. The integer processor IU 23 executes integer instructions, performing integer add, subtract, multiply, divide, compare, and binary logic computations with an arithmetic logic unit and the general purpose registers A, B, and C. Most integer instructions are single cycle instructions. The integer processor IU 23 writes and reads data in the L1 cache 48 over lines 54 and 65.

In example embodiments of the invention, the floating point processor 29 unit FPU receives floating point instructions over line 56 from the instruction queue 42, decoder 44 and issue logic 46 in the instruction unit 40. The floating point processor 29 unit FPU contains a multiply add array and floating point registers, to implement floating point operations such as multiply, add, divide, and multiply-add. The floating point processor 29 unit FPU is pipelined so that instructions may be issued back-to-back. The floating point processor 29 unit FPU writes and reads data in the L1 cache 48 over lines 58 and 65.

In example embodiments of the invention, the functional processor FU1 receives functional processing instructions over line 62 from the instruction queue 42, decoder 44 and issue logic 46 in the instruction unit 40. The functional processor FU1 contains specialized logic to perform, for example, vector processing. The functional processor FU1 may be pipelined so that instructions may be issued back-to-back. The functional processor FU1 buffers operands and results in the local vector registers V1, V2, and V3 in the functional processor and/or in the vector registers 35. For processes executed in the pipelined processor structure 13 within the processor core 1, the functional processor FU1 receives its instructions via instruction unit 40 over line 62. The functional processor FU1 writes and reads data in the L1 cache 48 over lines 64 and 65.

In example embodiments of the invention, the functional processor FU2 receives functional processing instructions over line 66 from the instruction queue 42, decoder 44 and issue logic 46 in the instruction unit 40. The functional processor FU2 contains specialized logic to perform, for example, vector processing. The functional processor FU2 may be pipelined so that instructions may be issued back-to-back. The functional processor FU2 buffers operands and results in local vector registers in the functional processor and/or in the vector registers 35. For processes executed in the pipelined processor structure 13 within the processor core 1, the functional processor FU2 receives its instructions via instruction unit 40 over line 66. The functional processor FU2 writes and reads data in the L1 cache 48 over lines 68 and 65.

In example embodiments of the invention, the processor core 1 may be connected through the bus arbitration logic 15 of the bus interface unit IF 21, to the bus 10 within its processor core. In example embodiments of the invention, the same instructions in the queue 42 of the instruction unit 40 are also loaded into the instruction queue 14 of the bus interface IF 21, to enable the instruction decode logic 16 in the bus interface IF 21 to determine whether either of the functional processor FU1 or FU2 is currently busy. In example embodiments of the invention, a process that is running on the local processor core 1 may utilize for a functional processing computation, the functional processor FU1 of the neighbor processor cores 2 and/or 3 in the multicore processor MP, if the neighboring functional processors FU1 of the neighbor processor cores 2 and/or 3 are not currently busy. In example embodiments of the invention, a specific new instruction, PARALLEL N, may be loaded into the instruction queue 14 of the bus interface IF 21 in the local processor core 1, signifying that the following N instructions in the queue are to be executed in parallel, if possible, in one or more neighboring functional processors FU1′ and/or FU1″, for example, of one or more respective neighbor processor cores 2 and/or 3.

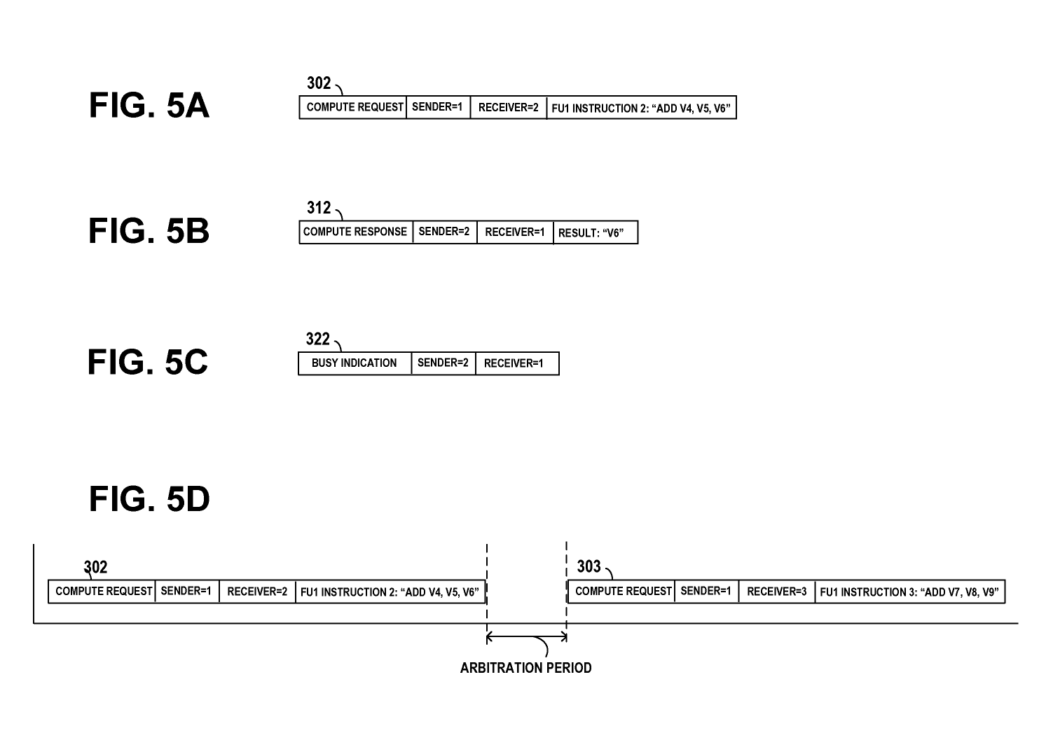

In example embodiments of the invention, in the neighbor processing core 2, for example, the register file 20 of the bus interface unit IF in the neighbor processing core 2, may receive the results of a parallel computation by functional processor FU1′ in the neighbor processing core 2, over its line 32. The results may be returned to the requesting processor core 1 in a compute response message 312 shown in FIG. 5B. The register file 20 of the bus interface unit IF in the neighbor processing core 2, may also receive the results of a parallel computation by functional processor FU2′ in the neighbor processing core 2, over its line 34, which may also be returned to the requesting processor core 1 in a compute response message 312 shown in FIG. 5B.

In example embodiments of the invention, the functional processor units of the processor cores 1, 2, or 3 may be used by the pipelined processor structure 13 within each respective processor core 1, 2, or 3 or by the bus interface IF 21, 21′, or 21″ in the respective processor core. The pipelined processor structure 13 may have a higher priority, however. If the pipelined processor structure 13 within a processor core is using a functional processor FU1 or FU2 within the same processor core to execute an instruction, the functional processor may be marked as busy. If the bus interface IF within the same processor core, in responding to a request from another processor core, tries to execute an instruction using the same busy functional processor, the execution fails and the bus interface IF will communicate to the requesting processor core over the bus 10 that the functional processor was busy.

In example embodiments of the invention, FIG. 2A shows processor core 1 including general processor 90 that may access random access memory RAM and/or programmable read only memory PROM in order to obtain stored program code and data for execution by the central processing unit CPU during processing. The RAM or PROM may generally store data and/or program code instructions received from the bus arbitrator 15 over line 12 from the fixed memories or removable storage 126 coupled to the bus 10. Control line 92 output from processor 90 is coupled to various logic units and storage units in the processor core 1, including the instruction decode logic 16 and the message forming logic 25 in the bus interface IF 21. The general processor 90 may also be included in the processor core 2 and the processor core 3.

Examples of the media for removable storage 126 are shown in FIG. 7, based on magnetic, electronic and/or optical technologies such as magnetic disks, optical disks, semiconductor memory circuit devices, and micro-SD semiconductor memory cards, may serve, for instance, as a program code and/or data input/output means. Code stored in the removable storage 126 may include any interpreted or compiled computer language including computer-executable instructions. The code and/or data may be used by the processor 90 to control various logic units and storage units in the processor core 1 and further, to create software modules such as operating systems, communication utilities, user interfaces, more specialized program modules, etc.

FIG. 2B illustrates an example embodiment of the instruction queue 14 and the instruction decode logic 16 in the bus interface 21 of FIG. 2A, in accordance with an example embodiment of the invention. Table 1 shows an example sequence of thirteen instructions that have been loaded into the instruction queue 14 and the instruction decode logic 16 in the bus interface IF 21 of processor core 1, to carry out a process of performing three vector computations in parallel in the FU1 functional processors of processor cores 1, 2, and 3.

TABLE 1

1: MOV V1, [A200h]
2: MOV V2, [A300h]
3: MOV V4, [A400h]
4: MOV V5, [A500h]
5: MOV V7, [A600h]
6: MOV V8, [A700h]
7: PARALLEL 3
8: ADD V1, V2, V3
9: ADD V4, V5, V6
A: ADD V7, V8, V9
B: MOV [A800h], V3
C: MOV [A900h], V6
D: MOV [AA00h], V9

In example embodiments of the invention, instructions numbered 1 to 6 are memory management instructions to copy the contents from respective memory locations in the L1 cache, for example, into the vector registers 35. In example embodiments of the invention, instruction number 7 is a specific new instruction, PARALLEL N, signifying that the following N instructions in the queue are to be executed in parallel, in one or more neighboring functional processors, for example, FU1, of one or more neighbor processor cores 2 and/or 3, if the neighboring functional processors are not busy. The instruction PARALLEL N is decoded by the instruction decode logic 16 in the in the bus interface IF. In the example in Table 1, the instruction PARALLEL 3 signifies that the following three instructions numbered 8, 9, and A (hex) are to be executed in parallel by the three respective processor cores 1, 2, and 3.

In example embodiments of the invention, if the neighboring functional processor FU1 is not available, then the functional processing computation is executed in the local functional processor FU1 of the local processor core 1. For example, the functional processor FU1 may be an identical vector processing unit in each of the processor cores 1, 2, and 3. If the processes running on neighbor processor core 2 do not use its functional processor FU1, then a process running on the local processing core 1 may utilize the functional processor FU1 in processor core 2 to carry out the functional processing computations. In this manner, the parallel operations carried out in otherwise unused functional processors make much more efficient use of the multicore processor MP.

In example embodiments of the invention, FIG. 2B shows that the first instruction following the PARALLEL 3 instruction is instruction number 8: ADD V1, V2, V3, which is decoded by the instruction decode logic 16 in the bus interface IF 21 to be an FU1 functional process that is transferred by the issue logic 18 as an internally executed instruction over line 28 to the functional processor FU1 in the processor core 1. The function performed by the functional processor FU1 is to add the value of V1 to the value of V2 and place the result in V3. The internal result V3 is transferred to over line 64 to the vector registers 35. Table 1 shows that the later instruction number B (hex) will store V3 in the L1 cache, for example, at the address specified in the instruction.

In example embodiments of the invention, the processor cores 2 and 3 may be performing a computation that is not using the vector processing capabilities of functional processor FU1. The processor core 1 loads vectors from memory to vector registers 35. The vector addition operations will occur on processor cores 2 and 3 in parallel with the programs that the processor cores 2 and 3 are currently executing. The results of the computation in processor cores 2 and 3 are transmitted back to the requesting processor core 1 in compute response messages 312 over the bus 10.

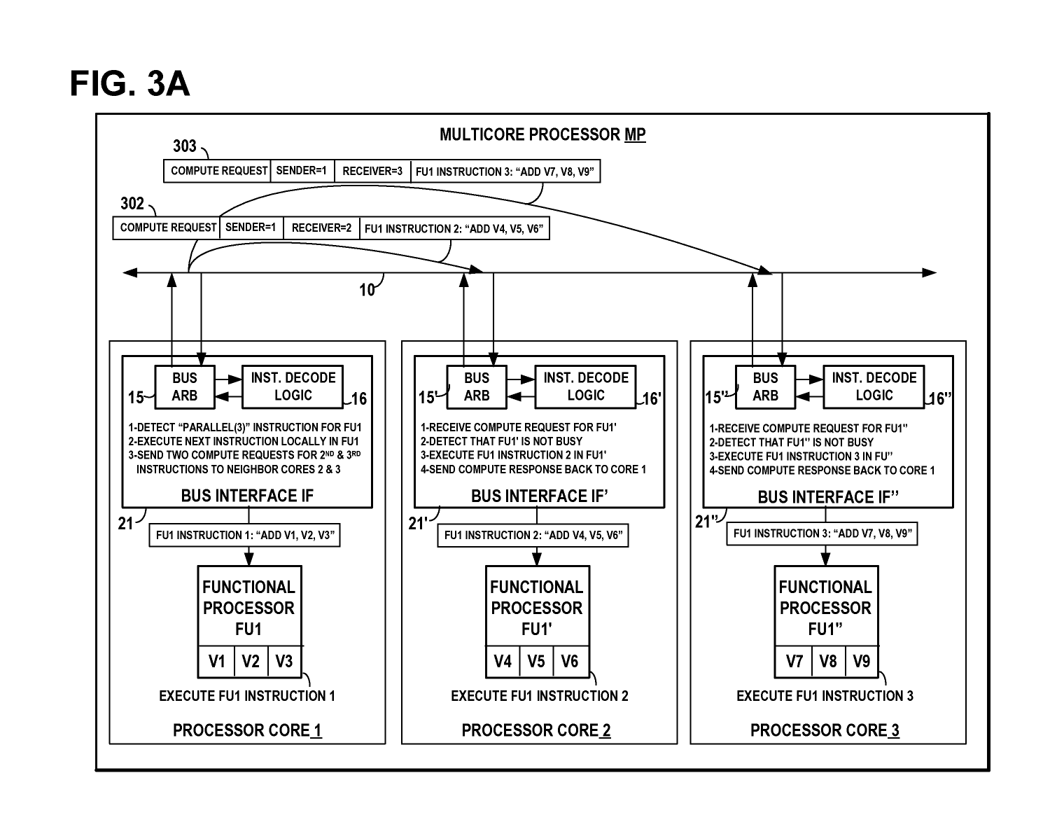

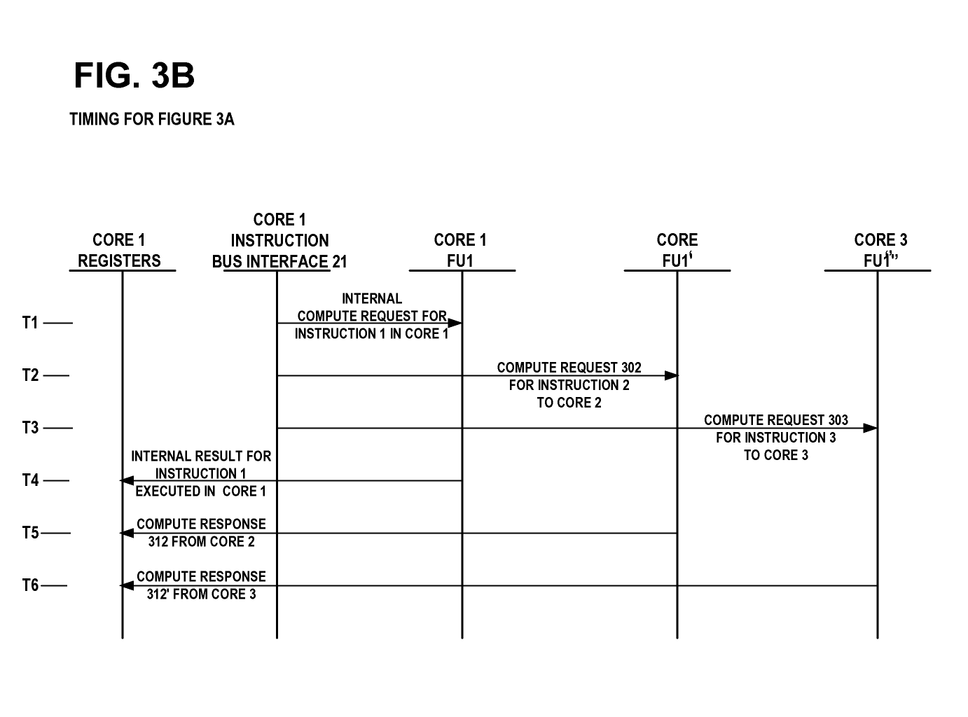

In example embodiments of the invention, FIG. 2B shows that the second instruction following the PARALLEL 3 instruction is instruction number 9: ADD V4, V5, V6, which is decoded by the instruction decode logic 16 in the bus interface IF 21 to be an FU1 functional process to be transmitted to processor core 2 for execution there. The message forming logic 25 forms the compute request message 302 shown in FIG. 5A, to be transmitted to the functional processor FU1′ in the processor core 2. The transmission of the compute request message 302 to the functional processor FU1′ in the processor core 2 is shown in FIG. 3A.

In example embodiments of the invention, FIG. 2C illustrates an example embodiment of the instruction queue 14′ in the bus interface IF′ 21′ in the processor core 2 of FIG. 2A. The instruction decode logic 16′ in the bus interface IF′ 21′ is connected through a receive buffer 19 and line 17 to the bus arbitration unit 15 in processor core 2, to receive the compute request messages 302 from other cores, such as processor core 1. The example compute request message 302 received by the instruction decode logic 16′ over line 17 from processor core 1 is FU1 Instruction 2: ADD V4, V5, V6.

In example embodiments of the invention, the duplicate instruction queue 14′ in processor core 2 is loaded with the same instruction sequence as has been loaded into the instruction queue 42 in the instruction unit 40 of the main pipeline processor structure 13 within processor core 2. Table 2 shows an example sequence of fifteen instructions that have been loaded into the instruction queue 14′ and the instruction decode logic 16′ in the bus interface IF′ 21′ of processor core 2, to carry out a process that does not involve vector computations in the FU1′ functional processor of processor core 2.

TABLE 2

1: MOV A, [67h]
2: MOV C, [6800h]
3: MOV B, [C]
4: ADD A, B
5: MOV [C], A
6: ADD C, 1
7: MOV A, [67h]
8: MOV B, [C]
9: ADD A, B
A: MOV [C], A
B: ADD C, 1
C: MOV A, [67h]
D: MOV B, [C]
E: ADD A, B
F: MOV [C], A

In example embodiments of the invention, instructions numbered 1-3, 5, 7-8, A, C-D, and F are memory management instructions to copy the contents from respective memory locations in the L1 cache, for example, into the general purpose registers. The instructions numbered 4, 6, 9, B, and E are integer arithmetic operations and not vector operations. Thus, the instruction decode logic 16′ may determine that the process represented by the instructions in the instruction queue 14′ does not involve vector computations in the functional processor FU1′ of processor core 2. Since the FU1′ functional processor is not currently busy, the instruction decode logic 16′ passes the FU1 Instruction 2: ADD V4, V5, V6 to the issue logic 18′ and over line 28 to the functional processor FU1′ for execution. The result V6 is then output from functional processor FU1′ over line 32 to the message forming logic 25′ where the compute response 312 is formed that includes the result “V6”. The compute response 312 is then passed over line 27 to the register file 20′ and then output over line 24 to the bus arbitrator 15′ to return the compute response 312 over the bus 10 to the processor core 1.

In example embodiments of the invention, FIG. 2B shows that the third instruction following the PARALLEL 3 instruction is instruction number A: ADD V7, V8, V9, which is decoded by the instruction decode logic 16 in the bus interface IF 21 to be an FU1 functional process to be transmitted to processor core 3 for execution there. The message forming logic 25 forms the compute request message 302 to be transmitted to the functional processor FU1″ in the processor core 3. The transmission of the compute request message 303 to the functional processor FU1″ in the processor core 3 is shown in FIG. 3A.

FIG. 2D illustrates an alternate example embodiment of the instruction queue 14′ in the bus interface IF′ 21′ in the processor core 2 of FIG. 2A, forming a busy indication message 322, in accordance with an example embodiment of the invention. The same example compute request message 302, as in FIG. 2C, is received by the instruction decode logic 16′ over line 17 from processor core 1: FU1 Instruction 2: ADD V4, V5, V6.

In example embodiments of the invention, the duplicate instruction queue 14′ in processor core 2 is loaded with a different instruction sequence than that in FIG. 2C, the new sequence comprising fourteen instructions that include some vector operations. The same new sequence has also been loaded into the instruction queue 42 in the instruction unit 40 of the main pipeline processor structure 13 within processor core 2. Table 3 shows the example sequence of fourteen instructions that have been loaded into the instruction queue 14′ and the instruction decode logic 16′ in the bus interface IF′ 21′ of processor core 2, to carry out a process that includes vector computations in the FU1′ functional processor of processor core 2.

TABLE 3

1: MOV V4, [A400h]
2: MOV V5, [A500h]
3: ADD V4, V5, V6
C: MOV [A900h], V6
1: MOV A, [77h]
2: MOV C, [7800h]
3: MOV B, [C]
4: ADD A, B
5: MOV [C], A
6: ADD C, 1
7: MOV A, [77h]
8: MOV B, [C]
9: ADD A, B
A: MOV [C], A

In example embodiments of the invention, instruction in queue position 3 is a vector arithmetic operation. Thus, the instruction decode logic 16′ may determine that the process represented by the instructions in the instruction queue 14′ does involve vector computations in the functional processor FU1′ of processor core 2. Since the FU1′ functional processor is currently busy, the instruction decode logic 16′ signals the busy status to the message forming logic 25′ where the busy indication 322 is formed. The busy indication 322 is then passed over line 27 to the register file 20′ and then output over line 24 to the bus arbitrator 15′ to return the busy indication 322 over the bus 10 to the processor core 1.

FIG. 3A shows an example of the multicore processor MP and illustrates an example embodiment of the processor core 1 detecting a “PARALLEL(3)” instruction for its functional processor FU1, in the instruction queue 14 of its bus interface IF 21, executing the next instruction 1 in queue position 8: ADD V1, V2, V3, in the queue and sending two compute requests 302 and 303 to processor cores 2 and 3 to respectively execute the second next instruction 2 in queue position 9: ADD V4, V5, V6, and third next instruction 3 in queue position A: ADD V7, V8, V9, in parallel, in accordance with an example embodiment of the invention.

FIG. 3B illustrates an example timing diagram of an example operation of the example embodiment of the invention shown in FIG. 3A, according to an embodiment of the present invention. The following example actions at times T1 to T3 may be taken in a different order and at different instants. At time T1, the processor core 1 bus interface 21 issues an internal compute request for the execution of instruction 1 in the functional processor FU1 in processor core 1. At time T2, the processor core 1 bus interface 21 issues compute request 302 to processor core 2 for the execution of instruction 2 in the functional processor FU1′ in processor core 2. At time T3, the processor core 1 bus interface 21 issues compute request 303 to processor core 3 for the execution of instruction 3 in the functional processor FU1″ in processor core 3. The following example actions at times T4 to T6 may be taken in a different order and at different instants. At time T4, the registers in processor core 1 receive the internal result for instruction 1 executed in processor core 1 and this action may occur at any time following time T1. At time T5, the registers in processor core 1 receive the compute response 312 from processor core 2 for instruction 2 executed in processor core 2 and this action may occur at any time following time T2. At time T6, the registers in processor core 1 receive the compute response 312′ from processor core 3 for instruction 3 executed in processor core 3 and this action may occur at any time following time T3.

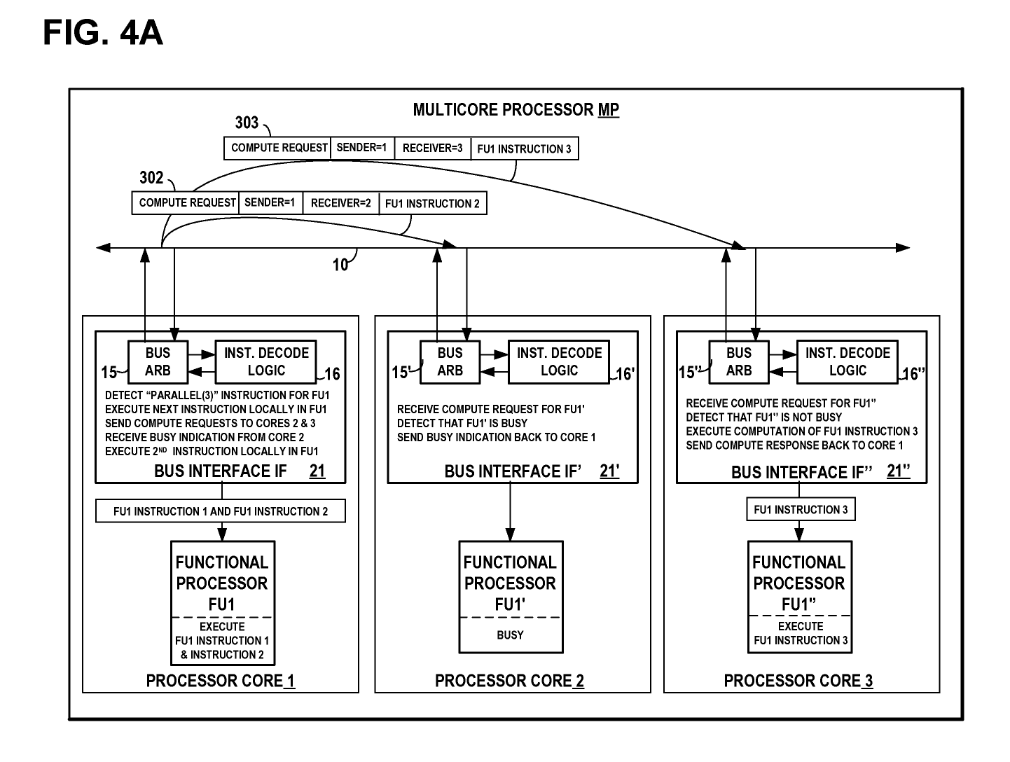

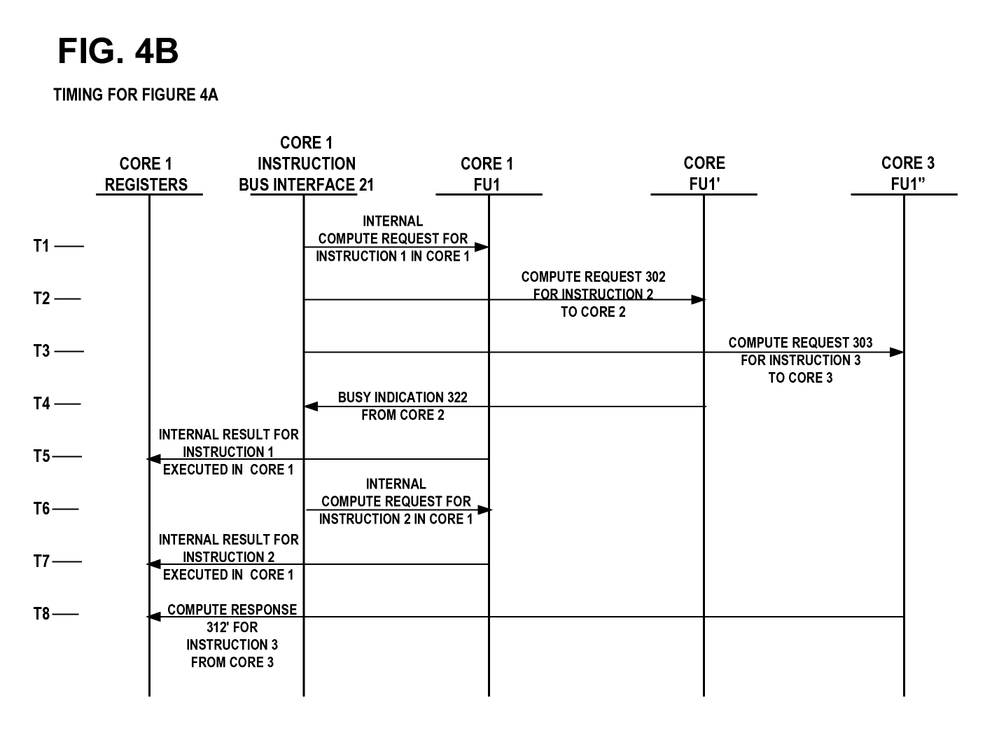

FIG. 4A illustrates an example embodiment of the processor core 2 detecting a busy condition for its functional processor FU1′ and sending a busy indication message 322 to the processor core 1. The processor 1 then executes the second next instruction 2 in queue position 9: ADD V4, V5, V6, in accordance with an example embodiment of the invention.

FIG. 4B illustrates an example timing diagram of an example operation of the example embodiment of the invention shown in FIG. 4A, according to an embodiment of the present invention. The following example actions at times T1 to T3 may be taken in a different order and at different instants. At time T1, the processor core 1 bus interface 21 issues an internal compute request for the execution of instruction 1 in the functional processor FU1 in processor core 1. At time T2, the processor core 1 bus interface 21 issues compute request 302 to processor core 2 for the execution of instruction 2 in the functional processor FU1′ in processor core 2. At time T3, the processor core 1 bus interface 21 issues compute request 303 to processor core 3 for the execution of instruction 3 in the functional processor FU1′ in processor core 3. At time T4, the processor core 2 detects a busy condition for its functional processor FU1′ and sends a busy indication message 322 to the processor core 1 and this action may occur at any time following time T2. At time T5, the registers in processor core 1 receive the internal result for instruction 1 executed in processor core 1 and this action may occur at any time following time T1. At time T6, the processor core 1 bus interface 21 issues an internal compute request for the execution of instruction 2 in the functional processor FU1 in processor core 1, which could not be executed in processor core 2 and this action may occur at any time following time T4. At time T7, the registers in processor core 1 receive the internal result for instruction 2 executed in processor core 1 and this action may occur at any time following time T6. At time T8, the registers in processor core 1 receive the compute response 312′ from processor core 3 for instruction 3 executed in processor core 3 and this action may occur at any time following time T3.

FIG. 5A illustrates an example embodiment of the compute request bus message 302, according to an embodiment of the present invention. The messages may include a message number, message ID and message payload. The data is encapsulated in fixed length packets, which have a start bit pattern to indicate the start of the packet. The rest of the packet is encoded in such a way that the bit pattern does not occur there. After the start code, there may be the sender code, which is the number of the core that sent the packet. The receiver code may follow the sender code, as the number of the processor core that is to be the receiver of the packet. In embodiments of the invention, the sender code may be after the receiver code. The rest of the packet is the actual payload data.

FIG. 5B illustrates an example embodiment of the compute response bus message 312, according to an embodiment of the present invention. The messages may include a message number, message ID and message payload.

FIG. 5C illustrates an example embodiment of the busy indication bus message 322, according to an embodiment of the present invention. The messages may include a message number and message ID, but no message payload is necessary.

FIG. 5D illustrates an example timing diagram of two compute request bus messages separated by an arbitration period, according to an embodiment of the present invention. The link layer of the bus 10 uses an arbitration period before sending a packet. The sender will wait for a short, random interval before trying to send the packet. After the interval, the sender checks if the bus is idle and if it is, it starts transmitting. The arbitration scheme enables all processor cores equal access to the bus 10.

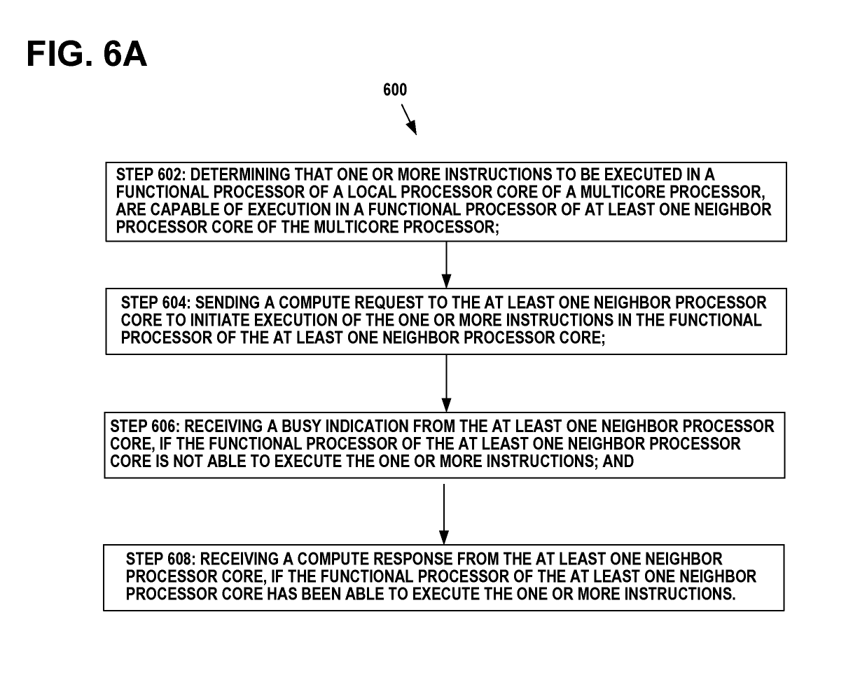

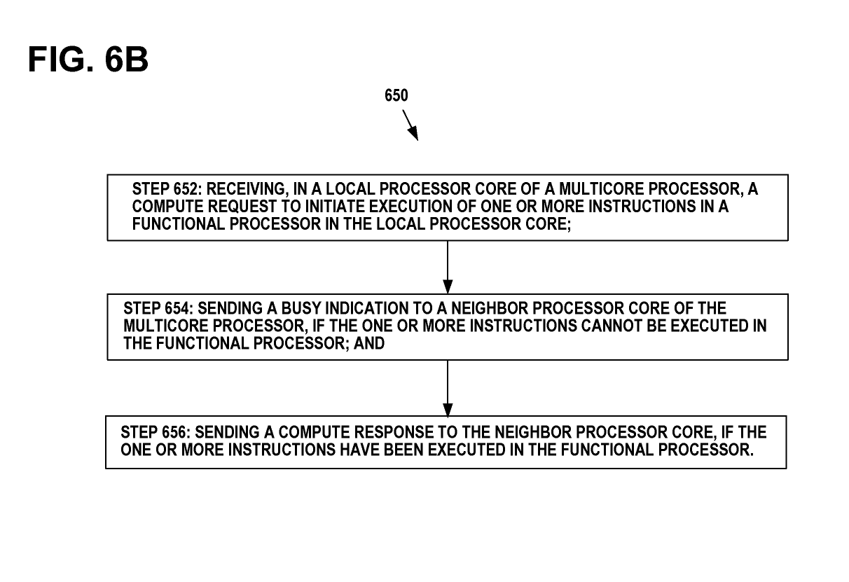

FIG. 6A illustrates an example flow diagram 600 of an example process carried out in the processor core 1, according to an embodiment of the present invention. FIG. 6A illustrates an example of steps in the procedure carried out by an apparatus, for example the multicore processor MP, in executing-in-place program code stored in the memory of the apparatus. The steps in the procedure of the flow diagram may be embodied as program logic stored in the memory of the apparatus in the form of sequences of programmed instructions which, when executed in the logic of the apparatus, carry out the functions of an exemplary disclosed embodiment. The steps may be carried out in another order than shown and individual steps may be combined or separated into component steps. Additional steps may be inserted into this sequence. The steps in the procedure are as follows:

Step 602: determining that one or more instructions to be executed in a functional processor of a local processor core of a multicore processor, are capable of execution in a functional processor of at least one neighbor processor core of the multicore processor;

Step 604: sending a compute request to the at least one neighbor processor core to initiate execution of the one or more instructions in the functional processor of the at least one neighbor processor core;

Step 606: receiving a busy indication from the at least one neighbor processor core, if the functional processor of the at least one neighbor processor core is not able to execute the one or more instructions; and

Step 608: receiving a compute response from the at least one neighbor processor core, if the functional processor of the at least one neighbor processor core has been able to execute the one or more instructions.

FIG. 6B illustrates an example flow diagram 650 of an example process carried out in the processor core 2, according to an embodiment of the present invention. FIG. 6B illustrates an example of steps in the procedure carried out by an apparatus, for example the multicore processor MP, in executing-in-place program code stored in the memory of the apparatus. The steps in the procedure of the flow diagram may be embodied as program logic stored in the memory of the apparatus in the form of sequences of programmed instructions which, when executed in the logic of the apparatus, carry out the functions of an exemplary disclosed embodiment. The steps may be carried out in another order than shown and individual steps may be combined or separated into component steps. Additional steps may be inserted into this sequence. The steps in the procedure are as follows:

Step 652: receiving, in a local processor core of a multicore processor, a compute request to initiate execution of one or more instructions in a functional processor in the local processor core;

Step 654: sending a busy indication to a neighbor processor core of the multicore processor, if the one or more instructions cannot be executed in the functional processor; and

Step 656: sending a compute response to the neighbor processor core, if the one or more instructions have been executed in the functional processor.

FIG. 7 illustrates an example embodiment of the invention, wherein examples of removable storage media 126 are shown, based on magnetic, electronic and/or optical technologies, such as magnetic disks, optical disks, semiconductor memory circuit devices and micro-SD semiconductor memory cards (SD refers to the Secure Digital standard), for storing data and/or computer program code as an example computer program product, in accordance with at least one embodiment of the present invention.

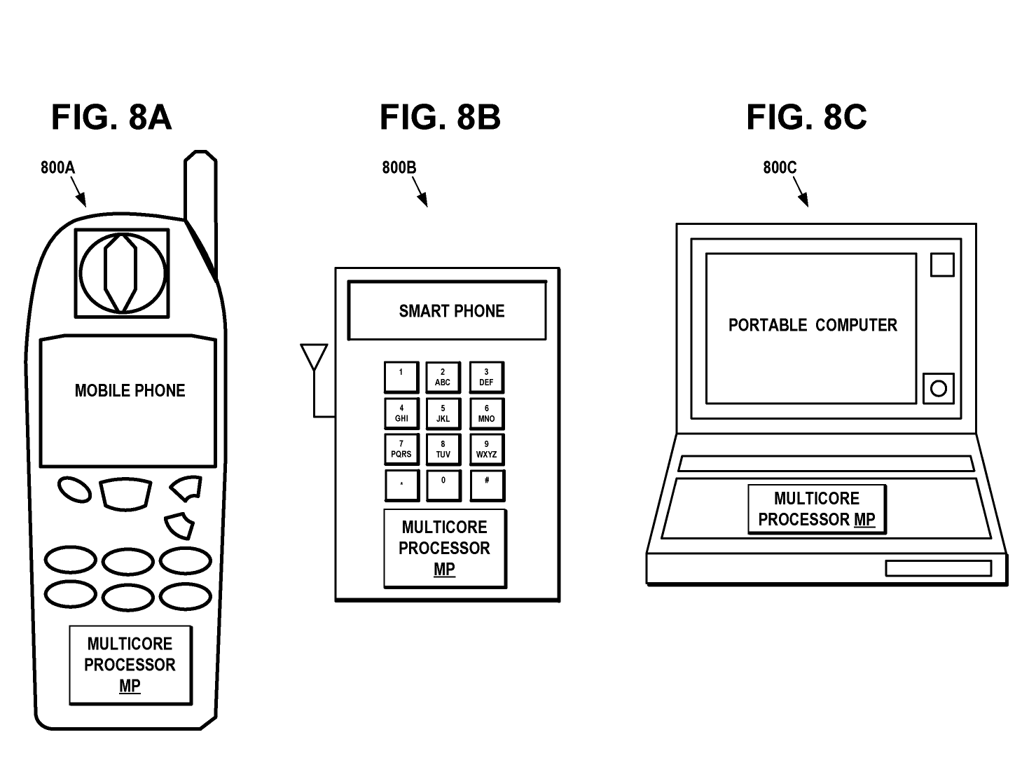

In example embodiments of the invention, the multicore processor MP is a component of an electronic device, such as for example a mobile phone 800A shown in FIG. 8A, a smart phone 800B shown in FIG. 8B, or a portable computer 800C shown in FIG. 8C, in accordance with at least one embodiment of the present invention.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable, non-transitory medium.

As indicated above, memory/storage devices include, but are not limited to, disks, optical disks, removable memory devices such as smart cards, subscriber identity modules (SIMs), wireless identification modules (WIMs), semiconductor memories such as random access memories (RAMs), read only memories (ROMs), programmable read only memories (PROMs), etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

1. A method, comprising:
determining that one or more instructions to be executed in a functional processor of a local processor core of a multicore processor, are capable of execution in a functional processor of at least one neighbor processor core of the multicore processor;
sending a compute request to the at least one neighbor processor core to initiate execution of the one or more instructions in the functional processor of the at least one neighbor processor core;
receiving a busy indication from the at least one neighbor processor core, if the functional processor of the at least one neighbor processor core is not able to execute the one or more instructions; and
receiving a compute response from the at least one neighbor processor core, if the functional processor of the at least one neighbor processor core has been able to execute the one or more instructions.

2. The method of claim 1, further comprising:
wherein the compute request includes the one or more instructions and operands.

3. The method of claim 1, further comprising:
wherein the compute response includes a computation result of executing the one or more instructions in the functional processor of the at least one neighbor processor core.

4. The method of claim 1, further comprising:
wherein if the busy indication is received from the at least one neighbor processor core, then executing the one or more instructions in the functional processor of the local processor core.

5. (canceled)

6. An apparatus comprising:
at least one processor;
at least one memory including computer program code;
the at least one memory and the computer program code configured to, with the at least one processor, cause the apparatus at least to:
determine that one or more instructions to be executed in a functional processor of a local processor core of a multicore processor, are capable of execution in a functional processor of at least one neighbor processor core of the multicore processor;
send a compute request to the at least one neighbor processor core to initiate execution of the one or more instructions in the functional processor of the at least one neighbor processor core;
receive a busy indication from the at least one neighbor processor core, if the functional processor of the at least one neighbor processor core is not able to execute the one or more instructions; and
receive a compute response from the at least one neighbor processor core, if the functional processor of the at least one neighbor processor core has been able to execute the one or more instructions.

7. The apparatus of claim 6, further comprising:
wherein the compute request includes the one or more instructions and operands,

8. The apparatus of claim 6, further comprising:
wherein the compute response includes a computation result of executing the one or more instructions in the functional processor of the at least one neighbor processor core.

9. The apparatus of claim 6, further comprising:
the at least one memory and the computer program code configured to, with the at least one processor, cause the apparatus at least to:
execute the one or more instructions in the functional processor of the local processor core, if the busy indication is received from the at least one neighbor processor core.

10. The apparatus of claim 6, further comprising:
a bus interface unit configured to send the compute request to the at least one neighbor processor core;
the bus interface unit further configured to receive the busy indication from the at least one neighbor processor core, if the functional processor of the at least one neighbor processor core is not able to execute the one or more instructions; and
the bus interface unit further configured to receive the compute response from the at least one neighbor processor core, if the functional processor of the at least one neighbor processor core has been able to execute the one or more instructions.

11. The apparatus of claim 6, further comprising:
the at least one memory and the computer program code configured to, with the at least one processor, cause the apparatus at least to:
duplicate in a bus interface in the local processor core, the one or more instructions to be executed in the functional processor of the local processor core;
decode in the bus interface, the one or more instructions that have been duplicated in the bus interface, to perform the determining that the one or more instructions are capable of execution in the functional processor of the at least one neighbor processor core; and
send by the bus interface over a bus coupled to the at least one neighbor processor core, the compute request to the at least one neighbor processor core to initiate execution of the one or more instructions in the functional processor of the at least one neighbor processor core.

12. The apparatus of claim 6, further comprising:
wherein the apparatus is a component of an electronic device drawn from the group consisting of a mobile phone, a smart phone, and a portable computer.

13. (canceled)

14. A method, comprising:
receiving, in a local processor core of a multicore processor, a compute request to initiate execution of one or more instructions in a functional processor in the local processor core;
sending a busy indication to a neighbor processor core of the multicore processor, if the one or more instructions cannot be executed in the functional processor; and
sending a compute response to the neighbor processor core, if the one or more instructions have been executed in the functional processor.

15. The method of claim 14, further comprising:
wherein the compute request includes the one or more instructions and operands.

16. The method of claim 14, further comprising:
wherein the compute response includes a computation result of executing the one or more instructions.

17. The method of claim 14, further comprising:
wherein the busy indication is sent to the neighbor processor core to cause the neighbor processor core to execute in its own functional processor, the one or more instructions.

18. (canceled)

19. An apparatus comprising:
at least one processor;
at least one memory including computer program code;
the at least one memory and the computer program code configured to, with the at least one processor, cause the apparatus at least to:
receive, in a local processor core of a multicore processor, a compute request to initiate execution of one or more instructions in a functional processor in the local processor core;
send a busy indication to a neighbor processor core of the multicore processor, if the one or more instructions cannot be executed in the functional processor; and
send a compute response to the neighbor processor core, if the one or more instructions have been executed in the functional processor.

20. The apparatus of claim 19, further comprising:
wherein the compute request includes the one or more instructions and operands.

21. The apparatus of claim 19, further comprising:
wherein the compute response includes a computation result of executing the one or more instructions.

22. The apparatus of claim 19, further comprising:
wherein the busy indication is sent to the neighbor processor core to cause the neighbor processor core to execute the one or more instructions in its own functional processor.

23. The apparatus of claim 19, further comprising:
a bus interface unit configured to receive the compute request;
the bus interface unit further configured to send the busy indication to the neighbor processor core, if the one or more instructions cannot be executed; and
the bus interface unit further configured to send the computation result to the neighbor processor core, if the one or more instructions have been executed.

24. (canceled)

25. (canceled)

26. (canceled)

27. (canceled)
